(19) United States
(12) Patent Application Publication
(10) Pub. No.: US 2010/0173798 A1
(43) Pub. Date: Jul. 8, 2010

(54) BIOCHIP IN WHICH HYBRIDIZATION CAN BE MONITORED, APPARATUS FOR MONITORING HYBRIDIZATION ON BIOCHIP AND METHOD OF MONITORING HYBRIDIZATION ON BIOCHIP

(75) Inventors: Young-eun KWON, Seongnam-si (KR); Sun-ok JUNG, Suwon-si (KR); Dong-ho LEE, Seongnam-si (KR); Nam HUH, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/624,639

(22) Filed: Nov. 24, 2009

(30) Foreign Application Priority Data
Jan. 6, 2009 (KR) 10-2009-0000826
Jan. 6, 2009 (KR) 10-2009-0000827
Jan. 6, 2009 (KR) 10-2009-0000828

(51) Int. Cl. C40B 30/04; C40B 40/06; C40B 60/12

(52) U.S. Cl. 506/9; 506/16; 506/39

(57) ABSTRACT

A biochip for monitoring hybridization is provided. The biochip includes a transparent substrate and a first probe region. The first probe region is disposed on the transparent substrate and has a plurality of analytical probes. The plurality of analytical probes are configured to bond to a sample having a fluorescence material. The plurality of analytical probes are used in analyzing the sample using fluorescence detection. The biochip further includes a second probe region disposed on the transparent substrate and having a plurality of monitoring probes used in monitoring hybridization according to a surface plasmon resonance in the second probe region. The biochip further includes a thin metal layer disposed between the second probe region and the transparent substrate.

### CROSS-REFERENCE TO RELATED APPLICATIONS

This application claims priority to Korean Patent Application No. 10-2009-0000826, filed on Jan. 6, 2009 Korean Patent Application No. 10-2009-0000827, filed on Jan. 6, 2009 and Korean Patent Application No. 10-2009-0000828, filed on Jan. 6, 2009, and all the benefits accruing therefrom under 35 U.S.C. §119, the contents of which in their entirety are herein incorporated by reference.

### BACKGROUND

1. Field

One or more exemplary embodiments relate to a biochip that analyzes a sample using a fluorescence detection method, and in which hybridization is monitored in real-time, and an apparatus that monitors the hybridization on the biochip in real-time, and a method of analyzing a sample using a fluorescence detection method using one biochip and monitoring the hybridization on the biochip in real-time.

2. Description of the Related Art

Biochips are devices that analyze a biological substance. The biochips are formed as relatively small chips similar to semiconductor chips, by combining enzymes, proteins, antibodies, DNA, microorganisms, animal and plant cells and components thereof, nerve cells, and other similar objects on the chips. For example, a DNA chip is typically formed by immobilizing a DNA oligomer on a solid substrate in a microarray, and various DNA-based tests can be conducted using the DNA chip. The proteins, antibodies, DNA oligomer, that are immobilized in advance on the substrate of the biochip are called a probe. When a sample is dropped on the biochip, only genes or proteins of the sample corresponding to a predetermined probe are bound to the probe, and remaining materials that are not bound are washed away in a subsequent process. Accordingly, the biometric information of a sample can be detected by testing to determine which probe of the biochip the sample is bound to. In particular, with the growth of research on the whole nucleotide sequence of human genes, interest in research on the function of the genes using a DNA chip, research on aspects of gene expression, understanding of congenital diseases and cures thereof, development of new drugs, and so forth have rapidly increased.

Tests conducted using biochips have various advantages. For example, as several million probes are typically integrated on a relatively small substrate, a number of various tests can be conducted using only a relatively small amount of a sample. Also, since several million reactions are typically performed in one chamber under the same conditions, data obtained from each of the probes can be compared directly and the test results can be analyzed quantitatively. Also, the test processes can be automated.

Various techniques have been suggested for checking which probes of the biochip a sample is bound to. One of the methods is a fluorescence detection method. In the fluorescence detection method, a fluorescent material which emits a predetermined color when excited by excitation light is adhered to a sample in advance, and then the sample is dropped on the biochip and excitation light is illuminated on the biochip to obtain a fluorescent image. By analyzing the fluorescent image, it can be determined which probe the sample is bound to. The fluorescent detection method is precise, and is thus appropriate for analyzing high-density biochips.

However, in the fluorescence detection method, when the remaining materials that did not take part in the reaction are present, it is difficult to accurately analyze the sample due to the fluorescent material bound to the remaining materials. Thus, a subsequent process, such as washing of the biochip, is typically conducted after completing the reaction. Thus, according to the fluorescence detection method, there are a number of restrictions on real-time monitoring of hybridization in which probes of a biochip are bound to samples. Consequently, in an analysis of hybridization using the fluorescence detection method, it is difficult to optimize the hybridization by controlling various conditions with respect to the hybridization. Also, it is difficult to check whether the hybridization is completed.

### SUMMARY

One or more exemplary embodiments include a biochip that is formed to analyze a sample using a fluorescence detection method and to monitor hybridization in real-time.

One or more exemplary embodiments include an apparatus capable of monitoring hybridization on a biochip that is formed to analyze a sample using a fluorescence detection method.

One or more exemplary embodiments include a method of precisely analyzing a sample using a fluorescence detection method using one biochip and monitoring hybridization on the biochip.

In one exemplary embodiment, a biochip includes a transparent substrate. The biochip further includes a first probe region disposed on the transparent substrate and having a plurality of analytical probes. The plurality of analytical probes are configured to bond to a sample having a fluorescence material. The plurality of analytical probes are used in analyzing the sample using fluorescence detection. The biochip further includes a second probe region disposed on the transparent substrate and having a plurality of monitoring probes used in monitoring hybridization according to a surface plasmon resonance in the second probe region. The biochip further includes a thin metal layer disposed between the second probe region and the transparent substrate.

In one exemplary embodiment, the biochip further includes a transparent dielectric layer disposed between the second probe region and the thing metal layer.

In one exemplary embodiment, the transparent dielectric layer is formed of at least one of silicon dioxide, diamond, and glassy carbon.

In one exemplary embodiment, a thickness of the transparent dielectric layer is about 1 angstrom to about 1 micrometer.

In one exemplary embodiment, the second probe region is disposed within the first probe region.

In one exemplary embodiment, the second probe region is disposed on the transparent substrate outside of the first probe region.

In one exemplary embodiment, a metal alignment mark is disposed on a surface of the transparent substrate, and the second probe region is disposed on a metal alignment mark.

In one exemplary embodiment, the second probe region protrudes over the transparent substrate.

In one exemplary embodiment, a groove is disposed in a surface of the transparent substrate, and the second probe region is disposed in the groove.

In one exemplary embodiment, a surface of the second probe region is disposed at one of a same height as a surface of the transparent substrate, and within the surface of the transparent substrate.

In one exemplary embodiment, the second probe region has a size of at least 1 square micrometer.

In one exemplary embodiment, a plurality of the second probe regions are disposed on the transparent substrate.

In one exemplary embodiment, the first probe region has a DNA oligomer as an analytical probe.

In one exemplary embodiment, the plurality of monitoring probes of the second probe region are one of selected from among the plurality of analytical probes of the first probe region to represent the plurality of analytical probes of the first probe region, and manipulated to represent an average of the plurality of analytical probes of the first probe region.

In one exemplary embodiment, a sample that is bound to the plurality of monitoring probes on the second probe region is a same sample type as the sample bound to the plurality of analytical probes on the first probe region.

In one exemplary embodiment, a sample that is bound to the plurality of monitoring probes on the second probe region is a different sample type than the sample bound to the plurality of analytical probes on the first probe region.

In one exemplary embodiment, the plurality of monitoring probes of the second probe region are introduced and immobilized on the biochip at a same time together with the plurality of analytical probes before manufacturing the biochip.

In one exemplary embodiment, the plurality of monitoring probes of the second probe region are introduced on the biochip during hybridization, and are configured to be bound to a surface of the thing metal layer as a self-assembled monolayer.

In one exemplary embodiment, a hybridization monitoring apparatus of a biochip includes a chamber which is coupled to the biochip and in which hybridization is performed. The hybridization monitoring apparatus further includes a prism which provides light to a lower portion of the biochip so as to generate surface plasmon resonance in the biochip. The hybridization monitoring apparatus further includes an optical detector which detects light reflected from the biochip. The hybridization monitoring apparatus further includes a processor which analyzes a degree of hybridization according to a signal transmitted from the optical detector and adjusts conditions of the hybridization.

In one exemplary embodiment, the biochip has a first probe region having a plurality of analytical probes, the plurality of analytical probes configured to bond to the sample, the plurality of analytical probes used in analyzing the sample using fluorescence detection and a second probe region having a plurality of monitoring probes used in monitoring the hybridization according to surface plasmon resonance in the second probe region.

In one exemplary embodiment, the sample is bound to both the plurality of analytical probes on the first probe region and the plurality of monitoring probes on the second probe region, in the chamber.

In one exemplary embodiment, the sample bound only to the plurality of analytical probes and a monitoring sample which is a sample used for monitoring that is to be bound only to the plurality of monitoring probes, are supplied to the chamber at substantially a same time.

In one exemplary embodiment, the monitoring sample comprises a material having a greater molecular weight than a molecular weight of the sample bound only to the plurality of analytical probes.

In one exemplary embodiment, the monitoring sample comprises oligomers bound with at least one of gold nanoparticles, a protein, and a polymer.

In one exemplary embodiment, the chamber comprises a first chamber and a second chamber, and hybridization is performed in both the first chamber and the second chamber.

In one exemplary embodiment, the biochip has a first probe region having a plurality of analytical probes used in analyzing the sample using fluorescence detection and a second probe region having a plurality of monitoring probes used in monitoring the hybridization according to surface plasmon resonance in the second probe region.

In one exemplary embodiment, the first probe region is disposed in the first chamber, and the second probe region is disposed in the second chamber.

In one exemplary embodiment, the sample bound to the plurality of analytical probes is supplied to the first chamber, and a monitoring sample bound to the plurality of monitoring probes, which is a sample used for monitoring, bound to the plurality of monitoring probes is supplied to the second chamber.

In one exemplary embodiment, the processor quantitatively analyses the degree of hybridization by comparing a result of the optical detector detecting light reflected from the biochip with previously obtained data from the optical detector.

In one exemplary embodiment, the processor optimizes hybridization conditions by comparing previously obtained information on optimum hybridization conditions with a result of the optical detector detecting light reflected from the biochip during the hybridization.

In one exemplary embodiment, a method of monitoring hybridization on a biochip includes forming the biochip having a first probe region and a second probe region on a transparent substrate, wherein a thin metal layer is disposed between the second probe region and the transparent substrate. The method further includes disposing the biochip in a chamber and conducting hybridization by supplying a sample to the chamber. The method further includes detecting a variation in a light absorption angle according to the hybridization on the second probe region using surface plasmon resonance in the second probe region while hybridization is being conducted in the chamber. The method further includes analyzing a degree of hybridization on the biochip based on the variation of the light absorption angle. The method further includes analyzing the result of the hybridization on the first probe region using fluorescence detection after the hybridization is completed.

In one exemplary embodiment, a first chamber and a second chamber that are separated from each other and are bound to one biochip.

In one exemplary embodiment, the first probe region is disposed in the first chamber, and the second probe region is disposed in the second chamber.

In one exemplary embodiment, an identical type of sample is supplied into both the first chamber and the second chamber.

In one exemplary embodiment, the sample bound to the plurality of analytical probes is supplied to the first chamber, and a monitoring sample which is a sample used for monitoring that is to be bound to the plurality of monitoring probes is supplied to the second chamber.

In one exemplary embodiment, the detecting of the variation in a light absorption angle according to the hybridization on the second probe region, using surface plasmon resonance in the second probe region, includes disposing a prism below the biochip, irradiating light at least to the second probe region in the biochip through the prism; and detecting the variation in the light absorption angle by observing an intensity of reflection light using an optical detector.

In one exemplary embodiment, the analyzing the degree of hybridization on the biochip based on the variation of the light absorption angle, includes comparing the variation of the light absorption angle with previously obtained data to analyze the degree of hybridization quantitatively.

In one exemplary embodiment, during the hybridization, optimizing hybridization conditions are obtained by comparing previously obtained information on the optimum hybridization conditions, with the variation of the light absorption angle during the hybridization.

### BRIEF DESCRIPTION OF THE DRAWINGS

The above and other aspects, advantages, and features of exemplary embodiments will become more apparent by describing in further detail exemplary embodiments thereof, with reference to the accompanying drawings, in which:

FIG. 1 is a top plan view of an exemplary embodiment of a biochip in which a fluorescence detection method and a surface plasmon resonance (“SPR”) detection method can be both conducted;

FIGS. 2A and 2B are cross-sectional views of exemplary embodiments of a second probe region of a biochip;

FIGS. 3A, 3B, and 3C are cross-sectional views of exemplary embodiments of a transparent substrate and the second probe region of a biochip;

FIGS. 4A and 4B are top plan views of exemplary embodiments of a first probe region and the second probe region on a surface of a biochip;

FIG. 5 is a cross-sectional view illustrating the principle of an exemplary embodiment of the SPR-detection method using the biochip illustrated in FIG. 1;

FIGS. 6A, 6B, and 6C are graphs of exemplary embodiments of light absorption angles due to SPR before a monitoring probe is introduced on a thin metal film, after a monitoring probe is introduced on a thin metal film, and after a target is bound to the monitoring probe, respectively;

FIG. 7 is a graph showing exemplary embodiments of variations in light absorption angles due to SPR before a monitoring probe is introduced on a thin metal film, after a monitoring probe is introduced on a thin metal film, and after a target sample is bound to the monitoring probe;

FIG. 8 is a schematic view of another exemplary embodiment of a hybridization monitoring apparatus;

FIG. 9 is a schematic view of another exemplary embodiment of a hybridization monitoring apparatus; and

FIG. 10 is a flowchart of another exemplary embodiment of a method of monitoring hybridization on a biochip.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

According to an exemplary embodiment, a biochip is formed to have both a region for analyzing a sample using a fluorescence detection method and a region for monitoring hybridization according to a surface plasmon resonance (“SPR”) detection method. In general, the SPR detection method is useful for real-time monitoring, but on the other hand, has lower sensitivity than the fluorescence detection method and utilizes a relatively large sensing area. For this reason, the SPR detection method is not frequently used for analysis of a relatively small sample. In the current exemplary embodiment, a biochip is formed such that the fluorescence detection method is applied for precise sample analysis, and the SPR detection method is applied for monitoring of hybridization. Thus, the advantages of the fluorescence detection method can be maintained and the hybridization can also be monitored in real-time.

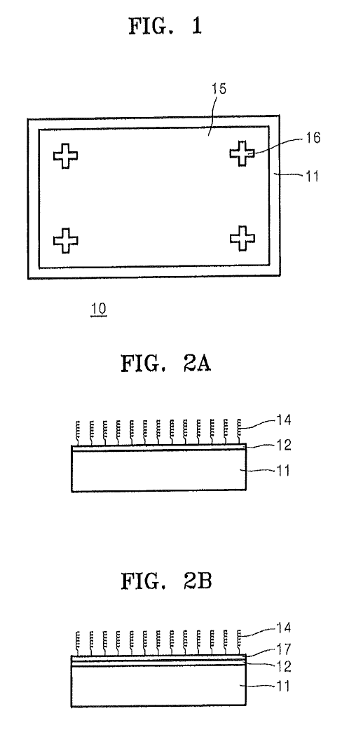

FIG. 1 is a schematic view illustrating an exemplary embodiment of a biochip 10 for performing both the fluorescence detection method and the SPR detection method. Referring to FIG. 1, the biochip 10 has a transparent substrate 11, and a first probe region 15 and a second probe region 16 formed on the transparent substrate 11. For example, in one exemplary embodiment the first probe region 15 may have a plurality of analytical probes, which may be used in sample analysis. The second probe region 16 which has a relatively small size and is formed within the first probe region 15 may have a plurality of monitoring probes, which may be used for monitoring hybridization. Accordingly, the first probe region 15 is analyzed according to the fluorescence detection method, and appreciated the second probe region 16 is monitored according to the SPR detection method.

FIGS. 2A and 2B are cross-sectional views illustrating the second probe region 16. Referring to FIG. 2A, a thin metal layer 12 is formed on the transparent substrate 11, and a plurality of monitoring probes 14 are disposed on the thin metal layer 12. The thin metal layer 12 is provided to generate SPR due to collective oscillation of electrons. Exemplary embodiments of the thin metal layer 12 may be formed of, for example, gold or other materials having similar characteristics. Exemplary embodiments include configurations wherein the monitoring probes 14 may not be readily directly formed on the thin metal layer 12 depending on the material of the monitoring probes 14. In such an exemplary embodiment, as illustrated in FIG. 2B, a transparent dielectric layer 17 may be further interposed between the thin metal layer 12 and the monitoring probes 14. Examples of the transparent dielectric layer 17 include silicon dioxide (“SiO2”), diamond, glassy carbon, and other materials having similar characteristics. The transparent dielectric layer 17 may be as thin as possible so as not to influence the SPR detection method. For example, in one exemplary embodiment the thickness of the transparent dielectric layer 17 may be about 1 micrometer or less (e.g., 1 angstrom).

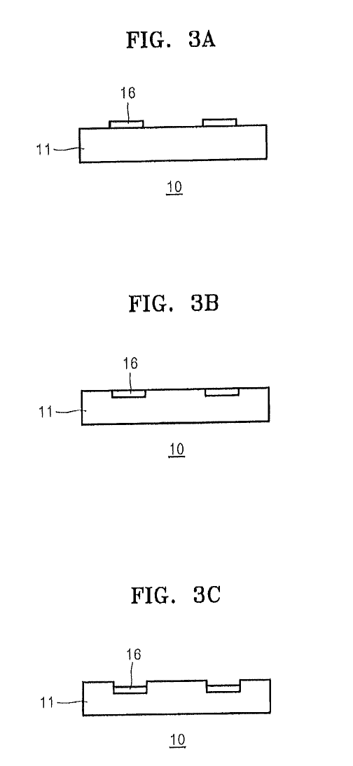

FIGS. 3A-3C are cross-sectional views illustrating configurations of the transparent substrate 11 and the second probe region 16 of the biochip 10. As illustrated in FIG. 3A, the second probe region 16 may be disposed to protrude out from the transparent substrate 11. Also, as illustrated in FIGS. 3B and 3C, a groove is formed in a surface of the transparent substrate 11 and the second probe region 16 may be disposed in the groove. As illustrated in FIG. 3B, the surface of the transparent substrate 11 and the surface of the second probe region 16 may be formed at substantially a same height, or as illustrated in FIG. 3C, the second probe region 16 may be disposed within a surface of the transparent substrate 11. The foregoing arrangement may be varied based on desired operational characteristics.

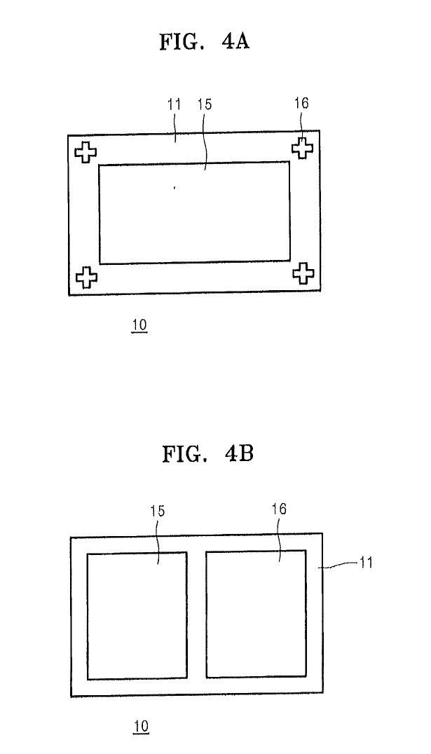

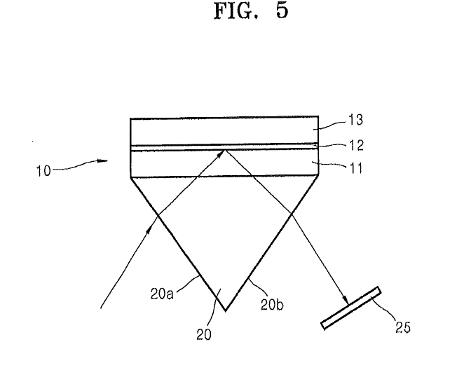

According to the current exemplary embodiment, the second probe region 16 may have a size of about 1 micrometer×1 micrometer (e.g., 1 mm×3 mm) larger, so that it can be sensed using the SPR detection method. For example, in one exemplary embodiment the second probe region 16 may be disposed within the first probe region 15 as illustrated in FIG. 1. However, according to other exemplary embodiments, the second probe region 16 may also be disposed outside the first probe region 15 as illustrated in FIGS. 4A and 4B. When a photolithography method is used in manufacturing a biochip, a metal alignment mark is disposed on the surface of the transparent substrate 11 of the biochip to align a mask, and this alignment mark may be used as the thin metal layer 12 of the second probe region 16. Alternative exemplary embodiments include configurations wherein the second probe region 16 may be used as an alignment mark for the biochip 10. In such an alternative exemplary embodiment, the second probe region 16 may also be formed in various patterns.

As described above, the analytical probes on the first probe region 15 may be typical probes for analyzing a sample using the fluorescence detection method. For example, in the exemplary embodiment wherein the biochip 10 is a DNA chip, the analytical probes may be DNA oligomers, and a sample may be an oligonucleotide taken from a human body. Meanwhile, the monitoring probes of the second probe region 16 may be selected so as to represent the DNA oligomers on the first probe region 15. In general, a set of multiple DNA oligomers having identical nucleotide sequences are arranged on the first probe region 15 in order to increase the accuracy of the analysis. Also, a number of sets of DNA oligomers having different nucleotide sequences may be arranged in arrays on the first probe region 15. DNA oligomers individually selected from each of the sets may be arranged in the second probe region 16. Alternatively, DNA oligomers whose nucleotide sequences are manipulated so as to represent an average of the DNA oligomers on the first probe region 15 may be used as the monitoring probes. Also, a plurality of the second probe regions 16 is illustrated in FIG. 1, which may be identical to one another. Alternative exemplary embodiments include configurations wherein different monitoring probes may be arranged on each of the second probe regions 16.

Also, a sample bound to the monitoring probes on the second probe region 16 may be a different sample type than a sample bound to the analytical probes on the first probe region 15. For example, in one exemplary embodiment, the analytical probes on the first probe region 15 may be DNA oligomers that are bound to a sample taken from a human body, and the monitoring probes on the second probe region 16 may be oligomers which are bound only to an additional sample used for monitoring (hereinafter referred to as a monitoring sample) that is provided for SPR detection only.

In one exemplary embodiment, the monitoring probes of the second probe region 16 may be introduced on the biochip 10 together with the analytical probes immediately before manufacturing the biochip 10 and may be immobilized thereon. However, alternative exemplary embodiments include configurations wherein the monitoring probes may also be introduced on the biochip 10 during the hybridization. In such an alternative exemplary embodiment, the principle of a self-assembled monolayer (“SAM”) may be used. For example, in the exemplary embodiment when the thin metal layer 12 is formed of gold, a ligand such as thiol for example may be bound by itself to a surface of the gold. Accordingly, when a ligand such as thiol is bound to an end of the monitoring probes and provided to the biochip 10, the monitoring probes can be bound to the second probe region 16 by themselves according to the SAM principle. The type of metal and the type of ligand that can be bound according to the SAM principle are known to those skilled in the art, and thus descriptions thereof will be omitted herein.

FIG. 5 is a cross-sectional view of an exemplary embodiment for explaining the principle of the SPR detection method. The principle of monitoring hybridization in the second probe region 16 using the SPR detection method will be described with reference to FIG. 5.

First, surface plasmon is a type of surface electromagnetic wave that proceeds along an interface between a thin metal layer and a dielectric layer. SPR phenomenon is known to be generated by collective oscillation of electrons generated on a surface of the thin metal layer. One method of generating surface plasmon resonance in an optical manner is by stacking a thin metal layer on an interface between two media having different refractive indices and allowing light to be incident on the interface at an angle greater than a total internal reflection angle. In this case, as the light is totally internally reflected, an evanescent wave having a relatively short effective distance toward a medium having a lower refractive index is generated on the interface of the two media. Furthermore, the thin metal layer needs to be thinner than the effective distance of the evanescent wave. For example, the thickness of the thin metal layer may be about 50 nm or less.

Referring to FIG. 5, the thin metal layer 12 is deposited in the second probe region 16 on an upper surface of the transparent substrate 11 of the biochip 10. A prism 20 is disposed below the transparent substrate 11. In FIG. 5, the prism 20 is illustrated to correspond only to the second probe region 16 for convenience. However, only one prism 20 may substantially be disposed over the whole region of the transparent substrate 11 of the biochip 10. In FIG. 5, a sample solution 13 is illustrated to flow over the thin metal layer 12. In the above configuration, when light is irradiated to the biochip 10 through a light incident surface 20a of the prism 20, the light is totally internally reflected on an interface between the transparent substrate 11 and the thin metal layer 12. The totally internally reflected light is emitted through a light exit surface 20b of the prism 20, and proceeds to an optical detector 25 that is disposed opposite to the light exit surface 20b. Then the light is absorbed at a predetermined incident angle according to a refractive index of a material formed on the thin metal layer 12 due to the SPR.

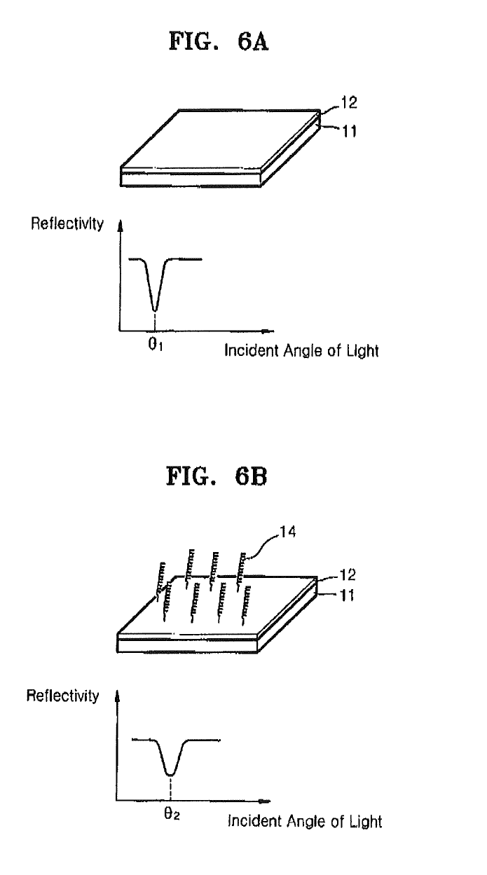

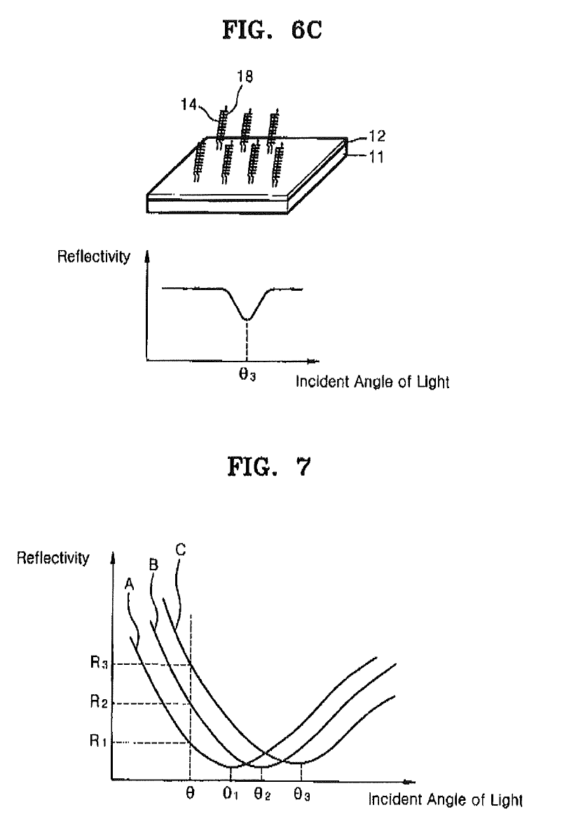

FIGS. 6A-6C are exemplary graphs showing light absorption that occurs due to SPR according to incident angles. FIG. 6A is a graph showing light absorption that occurs due to SPR according to incident angles before the monitoring probes 14 are introduced on the thin metal layer 12. FIG. 6B is a graph showing light absorption that occurs due to SPR according to incident angles after the monitoring probes 14 are introduced on the thin metal layer 12. FIG. 6C is a graph showing light absorption that occurs due to SPR according to incident angles after target samples 18 are bound to the monitoring probes 14. When the monitoring probes 14 are not introduced on the thin metal layer 12, as illustrated in FIG. 6A, and the sample solution 13 is dropped on the thin metal layer 12, light is absorbed due to SPR at an incident angle θ1. In FIGS. 6A, 6B, and 6C, a horizontal axis denotes incident angle of light, and a vertical axis denotes reflectivity. Meanwhile, when the monitoring probes 14 are introduced on the thin metal layer 12, the light absorption angle is shifted to θ2, as illustrated in FIG. 6B, due to the increased refractive index of the material on the thin metal layer 12. Also, when the target samples 18 are bound to the monitoring probes 14, the refractive index of the material on the thin metal layer 12 is further increased, and the light absorption angle is further shifted to θ3, as illustrated in FIG. 6C. In general, when the target samples 18 are bound to the monitoring probes 14, the variation in the refractive index is proportional to the amount of the bound target samples 18. Accordingly, the degree of hybridization on the biochip 10 can be readily determined by observing the above-described shift of the light absorption angle, and the degree of hybridization can be quantitated.

FIG. 7 shows the light absorption graphs of FIGS. 6A, 6B, and 6C altogether. In FIG. 7, a graph A shows light absorption due to SPR phenomenon before the monitoring probes 14 are introduced on the thin metal layer 12, a graph B shows light absorption after the monitoring probes 14 are introduced on the thin metal layer 12, and a graph C shows light absorption after the target samples 18 are bound to the monitoring probes 14. As illustrated in FIG. 7, as the refractive index of the material on the thin metal layer 12 is increased, the graphs are shifted to the right. Accordingly, by observing the light absorption angles θ1 through θ3 at which the light absorption is greatest while varying the incident angle of light incident on the thin metal layer 12 through the prism 20, the degree of hybridization can be checked in real-time. Also, from another perspective, as the refractive index of the material on the thin metal layer 12 is increased, reflectivity of the light at a predetermined angle θ is shifted from R1 to R3. Consequently, the degree of hybridization can be checked in real-time by observing the reflectivity at a fixed incident angle of light, that is, by measuring the intensity of the reflected light incident on the optical detector 25.

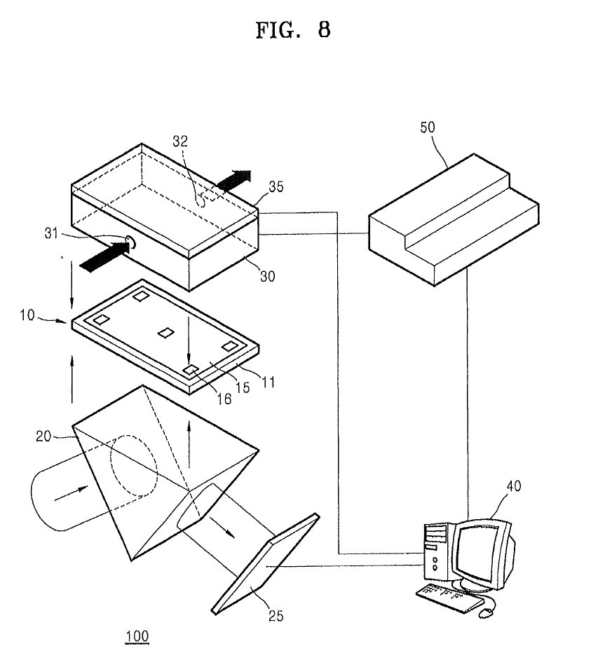

FIG. 8 illustrates an exemplary embodiment of a hybridization monitoring apparatus 100 in which hybridization is performed on the above-described biochip 10 and which monitors the hybridization. Referring to FIG. 8, the hybridization monitoring apparatus 100 includes a chamber 30 that is coupled to the biochip 10 and performs hybridization on the biochip 10, a prism 20 providing light to a lower portion of the biochip 10 for an SPR detection method, a temperature controller 35 controlling a temperature in the chamber 30, an optical detector 25 detecting light reflected from the biochip 10, a flow amount controller 50 controlling the flow amount of the sample supplied to the chamber 30, and a processor 40 analyzing the degree of hybridization according to a signal transmitted from the optical detector 25 and controlling the flow amount controller 50. Also, an agitator (not shown) may be further disposed in the chamber 30 to agitate the sample. In addition, a drier (not shown) may be further arranged in the chamber 30 in order to dry the biochip 10 after the biochip 10 is washed after the hybridization is ended.

The chamber 30 includes an inlet 31 through which a sample is supplied into the chamber 30 and an outlet 32 through which the sample is discharged from the chamber 30. In one exemplary embodiment, the chamber 30 may be coupled to an upper portion of the biochip 10. In such an exemplary embodiment, the chamber 30 is closely adhered to the upper portion of the biochip 10 and encapsulated in order to prevent leakage of the sample. Alternative exemplary embodiments include configurations wherein, the chamber 30 may be formed such that the biochip 10 is mounted inside the chamber 30. In such an exemplary embodiment, a transparent window (not shown) may be disposed below the chamber 30 so that light can be transmitted through a lower portion of the chamber 30. In this configuration, when a sample is supplied into the chamber 30 through the inlet 31, hybridization, in which a sample is bound to a corresponding probe on the biochip 10, is performed. Light is emitted to a lower portion of the biochip 10 through the prism 20, and the light reflected from the lower portion of the biochip 10 is detected by the optical detector 25 to monitor the degree of hybridization according to the SPR detection method.

A method of monitoring the hybridization using the illustrated hybridization monitoring apparatus 100 in accordance with an exemplary embodiment will be described with reference to FIG. 8. When a sample is supplied into the chamber 30 through the inlet 31, hybridization in which the sample is bound to a corresponding probe on the biochip 10 is performed. The processor 40 controls the flow amount controller 50 to control the amount of the sample supplied into the chamber 30. Also, the processor 40 controls the temperature controller 35 to control a reaction temperature inside the chamber 30.

According to an exemplary embodiment, the sample may be bound to both the analytical probes on the first probe region 15 and the monitoring probes on the second probe region 16. The analytical probes on the first probe region 15 may analyze a sample according to a fluorescence detection method. For example, when the biochip 10 is a DNA chip, the analytical probes may be DNA oligomers, and the sample may be an oligonucleotide extracted from a human body.

Furthermore, the monitoring probes on the second probe region 16 may be selected so as to represent the DNA oligomers on the first probe region 15. In one exemplary embodiment, a set of DNA oligomers having substantially identical nucleotide sequences are formed on the first probe region 15 in order to increase the accuracy of analysis, and also, a number of sets with different nucleotide sequences are formed in arrays on the second probe region. For example, in one exemplary embodiment, DNA oligomers selected from each of the sets may be arranged on the second probe region 16. Alternative exemplary embodiments include configurations wherein DNA oligomers whose nucleotide sequences are manipulated purposely to represent an average of the DNA oligomers of the first probe region 15 may be used as the monitoring probes. Also, a plurality of the second probe regions 16 are illustrated in the exemplary embodiment of FIG. 1, which may be identical to one another. Alternative exemplary embodiments include configurations wherein different monitoring probes may be arranged on each of the second probe regions 16.

According to another exemplary embodiment, a sample bound to the monitoring probes on the second probe region 16 may differ from a sample bound to the analytical probes on the first probe region 15. In such an exemplary embodiment, two different types of samples, that is, monitoring samples which are bound only to the monitoring probes to monitor hybridization with an actual sample which is to be analyzed, are supplied into the chamber 30 at a same time. The analytical probes on the first probe region 15 may be, for example, DNA oligomers that are bound to oligonucleotide samples extracted from a human body. On the other hand, the monitoring probes on the second probe region 16 may be additional oligomers that are bound to the monitoring samples. The monitoring samples may be formed of a material having a relatively large molecular weight so as to increase variation in the light absorption angle at which light is absorbed due to SPR. That is, when the monitoring samples are bound to the monitoring probes, the variation in the refractive index of the material on the thin metal layer 12 is increased using a material having a greater molecular weight than the actual sample, as the monitoring sample. Thus, the shift of the graphs of FIG. 7 is increased and accordingly, more precise SPR detection is possible. Examples of the materials of the monitoring samples may be oligomers bound with gold nanoparticles, protein, polymer, and other materials with similar characteristics.

When light is irradiated to the biochip 10 through the prism 20 while the hybridization is being processed, the light is totally internally reflected on an interface between the thin metal layer 12 and the transparent substrate 11 and is incident on the optical detector 25. Thus, SPR is generated as described above, and an incident angle at which light absorption occurs is varied according to the degree of hybridization. The variation in the light absorption angle can be sensed by measuring the intensity of light incident on the optical detector 25. The processor 40 can analyze the degree of hybridization quantitatively in real-time by comparing the result of the measurement with previously obtained experimental data.

Data regarding the relationship between the variation in the light absorption angle and the degree of hybridization can be accumulated in advance through experiments according to the types of the monitoring probes arranged in the second probe region 16. The accumulated data may be saved, for example, in a memory of the processor 40. Exemplary embodiments of the processor 40 may be a microprocessor, a computer, a central processing unit, or other similar devices. The processor 40 can calculate the degree of the hybridization accurately with reference to the above accumulated data on the relationship between the variation in the light absorption angle and the degree of the hybridization. In this manner, the processor 40 may detect optimum hybridization conditions by varying the conditions of hybridization by controlling the temperature controller 35 and the flow amount controller 40 and varying various conditions related to hybridization such as the reaction temperature and the flow amount of the sample. The time required to complete the hybridization can be reduced based on the information about the above optimum hybridization conditions. Then, when the hybridization is completed, the sample can be analyzed using the fluorescence detection method.

According to the above-described exemplary embodiments, a sample is analyzed using the fluorescence detection method and high sensitivity of the sample analysis is maintained, and the degree of hybridization can be monitored in real-time at the same time. Accordingly, a processing time interval for performing the hybridization can be ended immediately after completion of the hybridization, thereby reducing a time required for hybridization. Also, the degree of hybridization can be monitored quantitatively in real-time, and thus the hybridization can be processed only up to a desired degree and then halted, and the hybridization can be optimized by varying various operational conditions.

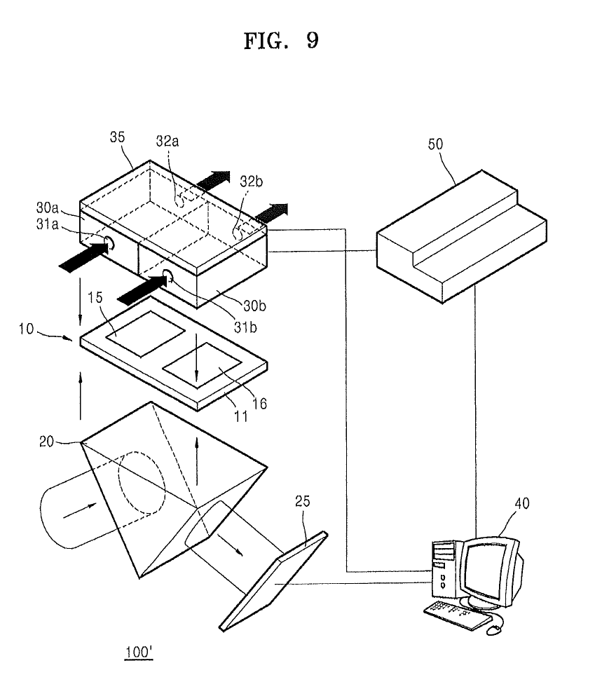

FIG. 9 illustrates a hybridization monitoring apparatus 100′ according to another exemplary embodiment. Referring to FIG. 9, in the present exemplary embodiment hybridization is performed in two separate chambers such as first and second chambers 30a and 30b for example, using identical or different target samples and is monitored. That is, compared to the hybridization monitoring apparatus 100 of FIG. 8, the hybridization monitoring apparatus 100′ of FIG. 9 is different in that the two separate chambers, such as first and second chambers 30a and 30b, are included. Referring to FIG. 9, a prism 20 for conducting an SPR detection method is disposed below the biochip 10. Also, the first and second chambers 30a and 30b are coupled to an upper portion of the biochip 10 to which probes are bound. Inlets 31a and 31b, through which a sample is supplied, and outlets 32a and 32b, through which the sample is discharged, are formed in the first and second chambers 30a and 30b, respectively.

Also, alternative exemplary embodiments include configurations wherein the biochip 10 may be formed in one chamber and a partition layer may be installed to separate the chamber into two, first and second chambers 30a and 30b. In such an alternative exemplary embodiment, first and second probe regions 15 and 16 are formed to respectively correspond to the first chamber 30a and the second chamber 30b on an upper surface of the biochip 10. For example, in one exemplary embodiment the first probe region 15 on the biochip 10 is formed to correspond to the first chamber 30a and may have general analytical probes for actually analyzing a sample according to the fluorescence detection method. The second probe region 16 is formed to correspond to the second chamber 30b and may have monitoring probes for monitoring hybridization according to the SPR detection method.

In this configuration, identical samples may be supplied to both the first chamber 30a and the second chamber 30b. For example, in one exemplary embodiment the samples may be an oligonucleotide extracted from a human body. Furthermore, the analytical probes on the first probe region 15 may be DNA oligomers. The monitoring probes on the second probe region 16 may be selected to represent the DNA oligomers on the first probe region 15. For example, in one exemplary embodiment the second probe region 16 may have DNA oligomers selected from each of the sets of the DNA oligomers of the first probe region 15, or DNA oligomers whose nucleotide sequences are manipulated purposely so as to represent an average of the DNA oligomers of the first probe region 15. According to the current exemplary embodiment, hybridization is performed with respect to an identical sample in the first chamber 30a and the second chamber 30b, and the degree of hybridization of the first chamber 30a can be inferred using the SPR detection method with respect to the second chamber 30b.

According to another exemplary embodiment, the monitoring probes on the second probe region 16 may be identical to the analytical probes of the first probe region 15. In such an exemplary embodiment, the degree of hybridization in the first chamber 30a may be inferred more accurately. Also, after the hybridization is completed, the second probe region 16 may undergo the sample analysis according to the fluorescence detection method.

In addition, two different types of samples may be supplied to the first chamber 30a and the second chamber 30b, respectively. For example, an actual sample which is to be analyzed may be supplied in the first chamber 30a, and monitoring samples bound only to the monitoring probes may be supplied to the second chamber 30b in order to monitor the hybridization. For example, the analytical probes of the first probe region 15 may be DNA oligomers that are bound to oligonucleotide samples extracted from a human body. Furthermore, the monitoring probes of the second probe region 16 may be additional oligomers that are bound to the monitoring samples. In such an exemplary embodiment, oligomers with increased molecular weight due to bonding with gold nanoparticles, protein, polymer, and so forth, having a relatively larger molecular weight than the actual sample, may be used as the monitoring sample. Thus, the shift of the light absorption angle in the graphs of FIG. 7 is increased as described above, and more precise SPR detection can be performed.

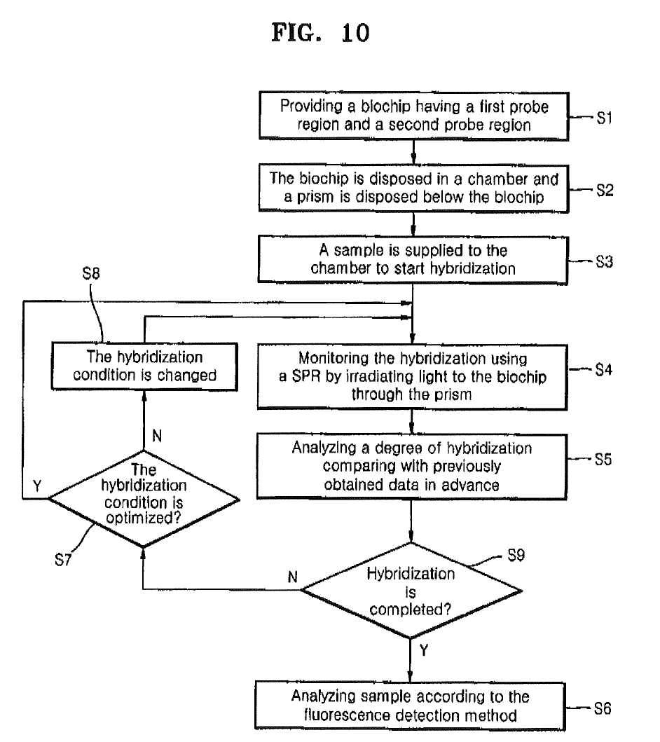

FIG. 10 is a flowchart of a method of monitoring the above-described hybridization on the biochip 10 in accordance with another exemplary embodiment. Referring to FIG. 1, first, the biochip 10, in which the first probe region 15 having a plurality of analytical probes used in analyzing a sample and the second probe region 16 having a plurality of monitoring probes used in monitoring hybridization are formed on the transparent substrate 11, is provided in step S1. As illustrated in FIG. 2A, the second probe region 16 is formed on the thin metal layer 12. Then, as illustrated in FIGS. 8 and 9, the biochip 10 is disposed in the chamber 30, and the prism 20 is disposed below the biochip 10 in step S2. Next, in step S3, a sample is supplied to the chamber 30 through the inlet 31 of the chamber 30 to start hybridization. As described above with reference to FIGS. 8 and 9, identical samples or different samples may be bound to the analytical probes of the first probe region 15 and the monitoring probes of the second probe region 16.

In step S4, while the hybridization is being performed, light is irradiated to the biochip 10, particularly, to the second probe region 16, through the prism 20 to monitor the hybridization on the biochip 10 in real-time. In detail, when light is irradiated to the second probe region 16, SPR is generated in the interface between the thin metal layer 12 and the transparent substrate 11 of the biochip 10, and light absorption occurs at a predetermined incident angle. Variation in the light absorption angle according to the hybridization in the second probe region 16 can be detected by observing the intensity of reflected light using the optical detector 25. Then, in step S5, the degree of hybridization in the biochip 10, particularly, in the first probe region 15, can be quantitatively analyzed by comparing the detection result with previously obtained data. In step S6, a determination is made as to whether the hybridization is completed. In step S9, when it is determined based on the analysis that the hybridization is completed, the biochip 10 is taken out to analyze the sample according to the fluorescence detection method.

When the hybridization is not completed, the hybridization is further performed while monitoring the hybridization according to the SPR detection method. Whether the hybridization conditions are optimized can be determined by comparing data on the optimum hybridization conditions that are obtained previously through experiments, with the above-described analysis result in step S7. When optimum hybridization conditions are not satisfied, the hybridization conditions such as reaction temperature can be varied in step S8.

The present disclosure should not be construed as being limited to the exemplary embodiments set forth herein. Rather, these exemplary embodiments are provided so that this disclosure will be thorough and complete and will fully convey the concept of the exemplary embodiments to those skilled in the art.

Further, although the exemplary embodiments have been shown and described herein, it will be understood by those of ordinary skill in the art that various changes and modifications in form and details may be made therein without departing from the spirit or scope of the claimed invention as defined by the following claims.

What is claimed is:

1. A biochip, comprising:
a transparent substrate;
a first probe region disposed on the transparent substrate and having a plurality of analytical probes, the plurality of analytical probes configured to bond to a sample having a fluorescence material, the plurality of analytical probes used in analyzing the sample using fluorescence detection;
a second probe region disposed on the transparent substrate and having a plurality of monitoring probes used in monitoring hybridization according to a surface plasmon resonance in the second probe region; and
a thin metal layer interposed between the second probe region and the transparent substrate.

2. The biochip of claim 1, further comprising a transparent dielectric layer disposed between the second probe region and the thin metal layer.

3. The biochip of claim 2, wherein the transparent dielectric layer comprises at least one of silicon dioxide, diamond, and glassy carbon.

4. The biochip of claim 2, wherein a thickness of the transparent dielectric layer is about 1 angstrom to about 1 micrometer.

5. The biochip of claim 1, wherein the second probe region is disposed within the first probe region.

6. The biochip of claim 1, wherein the second probe region is disposed on the transparent substrate outside of the first probe region.

7. The biochip of claim 1, wherein a metal alignment mark is disposed on a surface of the transparent substrate, and the second probe region is disposed on the metal alignment mark.

8. The biochip of claim 1, wherein the second probe region protrudes over the transparent substrate.

9. The biochip of claim 1, wherein a groove is disposed in a surface of the transparent substrate, and the second probe region is disposed in the groove.

10. The biochip of claim 9, wherein a surface of the second probe region is disposed at one of a same height as a surface of the transparent substrate, and within the surface of the transparent substrate.

11. The biochip of claim 1, wherein the second probe region has a size of at least 1 square micrometer.

12. The biochip of claim 1, wherein a plurality of the second probe regions are disposed on the transparent substrate.

13. The biochip of claim 1, wherein the first probe region has a DNA oligomer as at least one of the plurality of analytical probes.

14. The biochip of claim 1, wherein the plurality of monitoring probes of the second probe region are one of selected from among the plurality of analytical probes of the first probe region to represent the plurality of analytical probes of the first probe region, and manipulated so as to represent an average of the plurality of analytical probes of the first probe region.

15. The biochip of claim 14, wherein a sample that is bound to the plurality of monitoring probes on the second probe region is a same sample type as the sample bound to the plurality of analytical probes on the first probe region.

16. The biochip of claim 1, wherein a sample that is bound to the plurality of monitoring probes on the second probe region is a different sample type than the sample bound to the plurality of analytical probes on the first probe region.

17. The biochip of claim 1, wherein the plurality of monitoring probes of the second probe region are introduced and immobilized on the biochip at a same time together with the plurality of analytical probes before manufacturing the biochip.

18. The biochip of claim 1, wherein the plurality of monitoring probes of the second probe region are introduced on the biochip during hybridization, and are configured to be bound to a surface of the thin metal layer as a self-assembled monolayer.

19. A hybridization monitoring apparatus of a biochip, comprising:
a chamber which is coupled to the biochip and in which hybridization is performed;
a prism which provides light to a lower portion of the biochip to generate surface plasmon resonance in the biochip;
an optical detector which detects light reflected from the biochip; and
a processor which analyzes a degree of hybridization according to a signal transmitted from the optical detector and adjusts conditions of the hybridization.

20. The hybridization monitoring apparatus of claim 19, wherein the biochip has a first probe region having a plurality of analytical probes, the plurality of analytical probes configured to bond to the sample, the plurality of analytical probes used in analyzing the sample using fluorescence detection and a second probe region having a plurality of monitoring probes used in monitoring the hybridization according to surface plasmon resonance in the second probe region.

21. The hybridization monitoring apparatus of claim 20, wherein the sample is bound to both the plurality of analytical probes on the first probe region and the plurality of monitoring probes on the second probe region, in the chamber.

22. The hybridization monitoring apparatus of claim 20, wherein the sample bound only to the plurality of analytical probes and a monitoring sample, which is a sample used for monitoring that is to be bound only to the plurality of monitoring probes, are supplied to the chamber at substantially a same time.

23. The hybridization monitoring apparatus of claim 22, wherein the monitoring sample comprises a material having a greater molecular weight than a molecular weight of the sample bound only to the plurality of analytical probes.

24. The hybridization monitoring apparatus of claim 23, wherein the monitoring sample comprises oligomers bound with at least one of gold nanoparticles, a protein, and a polymer.

25. The hybridization monitoring apparatus of claim 19, wherein the chamber comprises a first chamber and a second chamber, and hybridization is performed in both the first chamber and the second chamber.

26. The hybridization monitoring apparatus of claim 25, wherein the biochip has a first probe region having a plurality of analytical probes used in analyzing the sample using fluorescence detection and a second probe region having a plurality of monitoring probes used in monitoring the hybridization according to surface plasmon resonance in the second probe region.

27. The hybridization monitoring apparatus of claim 26, wherein the first probe region is disposed in the first chamber, and the second probe region is disposed in the second chamber.

28. The hybridization monitoring apparatus of claim 27, wherein the sample bound to the plurality of analytical probes is supplied to the first chamber, and a monitoring sample bound to the plurality of monitoring probes, which is a sample used for monitoring, is supplied to the second chamber.

29. The hybridization monitoring apparatus of claim 19, wherein the processor quantitatively analyses the degree of hybridization by comparing a result of the optical detector detecting light reflected from the biochip with previously obtained data from the optical detector.

30. The hybridization monitoring apparatus of claim 19, wherein the processor optimizes hybridization conditions by comparing previously obtained information on optimum hybridization conditions with a result of the optical detector detecting light reflected from the biochip during the hybridization.

31. A method of monitoring hybridization on a biochip, the method comprising:
forming the biochip having a first probe region and a second probe region on a transparent substrate, wherein a thin metal layer is disposed between the second probe region and the transparent substrate;
disposing the biochip in a chamber;
conducting hybridization by supplying a sample to the chamber;
detecting a variation in a light absorption angle according to the hybridization on the second probe region using surface plasmon resonance in the second probe region while hybridization is being conducted in the chamber;
analyzing a degree of hybridization on the biochip based on the variation of the light absorption angle; and
analyzing the result of the hybridization on the first probe region using fluorescence detection after the hybridization is completed.

32. The method of claim 31, wherein the first probe region has a plurality of analytical probes used in analyzing the sample using fluorescence detection, and the second probe region has a plurality of monitoring probes used in monitoring the hybridization using surface plasmon detection in the second probe region.

33. The method of claim 32, wherein the first probe region has DNA oligomers as the analytical probes.

34. The method of claim 32, wherein the plurality of monitoring probes of the second probe region are selected from the plurality of analytical probes of the first probe region to represent the plurality of analytical probes of the first probe region, or are manipulated to represent an average of the plurality of analytical probes of the first probe region.

35. The method of claim 34, wherein a sample that is bound to the plurality of monitoring probes on the second probe region is a same sample type as the sample bound to the plurality of analytical probes on the first probe region.

36. The method of claim 32, wherein a sample that is bound to the plurality of monitoring probes on the second probe region is of a different sample type from the sample bound to the plurality of analytical probes on the first probe region.

37. The method of claim 36, wherein an actual sample bound to the plurality of analytical probes, and a monitoring sample, which is a sample used for monitoring that is to be bound only to the plurality of monitoring probes, are supplied to the chamber at substantially a same time.

38. The method of claim 37, wherein the monitoring sample comprises a material having a greater molecular weight than a molecular weight of the sample bound to the plurality of analytical probes.

39. The method of claim 38, wherein the monitoring sample comprises oligomers bound with at least one of gold nanoparticles, a protein, and a polymer.

40. The method of claim 31, wherein a first chamber and a second chamber are separated from each other and are bound to one biochip.

41. The method of claim 40, wherein the first probe region is disposed in the first chamber, and the second probe region is disposed in the second chamber.

42. The method of claim 41, wherein the first probe region has a plurality of analytical probes used in analyzing the sample using fluorescence detection, and the second probe region has a plurality of monitoring probes used in monitoring the hybridization according to surface plasmon detection in the second probe region.

43. The method of claim 42, wherein the first probe region has DNA oligomers as the analytical probes.

44. The method of claim 42, wherein the plurality of monitoring probes of the second probe region is selected from the plurality of analytical probes of the first probe region to represent the plurality of analytical probes of the first probe region, or are manipulated to represent an average of the plurality of analytical probes of the first probe region.

45. The method of claim 44, wherein an identical type of sample is supplied into both the first chamber and the second chamber.

46. The method of claim 42, wherein the sample bound to the plurality of analytical probes is supplied to the first chamber, and a monitoring sample which is a sample used for monitoring that is to be bound to the plurality of monitoring probes is supplied to the second chamber.

47. The method of claim 46, wherein the monitoring sample comprises a material having a greater molecular weight than a molecular weight of the sample bound to the plurality of analytical probes.

48. The method of claim 47, wherein the monitoring sample comprises oligomers bound with at least one of gold nanoparticles, a protein, and a polymer.

49. The method of claim 31, wherein the detecting of the variation in a light absorption angle according to the hybridization on the second probe region, using surface plasmon resonance in the second probe region, comprises:
disposing a prism below the biochip;
irradiating light at least to the second probe region in the biochip through the prism; and
detecting the variation in the light absorption angle by observing an intensity of reflection light using an optical detector.

50. The method of claim 31, wherein the analyzing the degree of hybridization on the biochip based on the variation of the light absorption angle, includes comparing the variation of the light absorption angle with previously obtained data to analyze the degree of hybridization quantitatively.

51. The method of claim 50, further comprising optimizing hybridization conditions by comparing previously obtained information on the optimum hybridization conditions, with the variation of the light absorption angle during the hybridization.
